(19) United States
(12) Patent Application Publication
(10) Pub. No.: US 2011/0137661 A1
(43) Pub. Date: Jun. 9, 2011

(54) QUANTIZING DEVICE, ENCODING DEVICE, QUANTIZING METHOD, AND ENCODING METHOD

(75) Inventors: Toshiyuki Morii, Kanagawa (JP); Kaoru Sato, Kanagawa (JP); Hiroyuki Ehara, Kanagawa (JP)

(73) Assignee: PANASONIC CORPORATION, Osaka (JP)

(21) Appl. No.: 13/057,162

(22) PCT Filed: Aug. 7, 2009
(86) PCT No.: PCT/JP2009/003798

§ 371 Date: Feb. 2, 2011

(30) Foreign Application Priority Data
Aug. 8, 2008 (JP) 2008-205643
Mar. 12, 2009 (JP) 2009-059502
Apr. 9, 2009 (JP) 2009-095260

(51) Int. Cl. G10L 21/00

(52) U.S. Cl. 704/500

(57) ABSTRACT

A quantizing device for more efficient quantization realized by lessening the computational complexity of quantization of a balance weighting factor. The device includes a power/correlation calculating unit (201), an intermediate value calculating unit (202), a codebook (203), a searching unit (204), and a decoding unit (205). The power/correlation calculating unit (201) determines the value of the correlation between an L signal and an M signal and the value of the correlation between an R signal and the M signal and calculates the power of the M signal. The intermediate value calculating unit (202) determines two intermediate values by using the power of the M signal and the values of the correlations. The codebook (203) holds scalar values. The searching unit (204) selects a coefficient for balance adjustment of the amplitude of the M signal with respect to the L signal from among the scalar values according to the two intermediate values. The decoding unit (205) determines the coefficient for balance adjustment of the M signal with respect to the R signal by using the selected coefficient for balance adjustment of the M signal with respect to the L signal on the basis of the quantitative relation between the amplitudes of the signals of when the M signal is generated by down-mixing the L and R signals.

### TECHNICAL FIELD

The present invention relates to a quantizing apparatus, an encoding apparatus, a quantizing method and a encoding method, and relates to, for example, a quantizing apparatus, an encoding apparatus and a quantizing method adopting an intensity stereo method, which is a method of encoding a stereo audio signal at a low bit rate.

### BACKGROUND ART

Mobile communications essentially requires compressed coding of digital information such as sound/speech and images, for efficient use of transmission band. Especially, in sound/speech codec (coder/decoder) technology widely used for mobile telephones, there is a growing demand for conventional efficient coding of high compression rates, in order to achieve better sound/speech quality.

Furthermore, in recent years, standardization of a multilayer-structure scalable codec by ITU-T (International Telecommunication Union Telecommunication Standardization Sector) and MPEG (Moving Picture Experts Group) is being discussed, representing a demand for a sound/speech codec of higher efficiency and better sound/speech quality. Also, in recent years, there is a growing trend to set high bit rates (e.g. 16-32 kbps) with a sound/speech codec and seek satisfaction of needs for good sound/speech quality and realistic sensation (using multichannel configuration, stereo audio system, etc.).

The intensity stereo method is known as a method of encoding a stereo audio signal at a low bit rate. The intensity stereo method employs a technique of multiplying a monaural signal (hereinafter referred to as “M signal”) by a scaling coefficient to generate a left channel signal (hereinafter referred to as “L signal”) and a right channel signal (hereinafter referred to as “R signal”). This technique is also referred to as “amplitude panning.”

The most fundamental technique of amplitude panning is to multiply a time domain M signal by gain factors (balancing weight coefficients) for amplitude panning, to provide an L signal and an R signal (see, for example, non-patent literature 1).

Another technique is to multiply an M signal by a balancing weight coefficient per frequency component or per frequency group, in the frequency domain, to find an L signal and an R signal (see, for example, non-patent literature 2).

By encoding a balancing weight coefficient as a parametric stereo coding parameter, stereo signal coding is made possible (see, for example, patent literature 1 and patent literature 2). A “balancing weight coefficient” is explained as a balance parameter in patent literature 1 and as ILD (level difference) in patent literature 2.

Heretofore, a stereo signal formed with an L signal and an R signal has been encoded in an efficient fashion as shown in non-patent literature 1 and non-patent literature 2 and patent literature 1 and patent literature 2.

Especially, patent literature 1 discloses finding the ratio of sound volume between the left and the right, which is the balancing weight coefficient in the intensity stereo method, and encoding that ratio.

### CITATION LIST

### Patent Literature

### PTL 1

Published Japanese Translation No. 2004-535145 of the PCT International Publication

### PTL 2

Published Japanese Translation No. 2005-533271 of the PCT International Publication

### Non-Patent Literature

### NPL 1

V. Pulkki and M. Karjalainen, “Localization of amplitude-panned virtual sources I: Stereophonic panning”, Journal of the Audio Engineering Society, Vol. 49, No. 9, September 2001, pp. 739-752

### NPL 2

B. Cheng, C. Ritz and I. Burnett, “Principles and analysis of the squeezing approach to low bit rate spatial audio coding”, proc. IEEE ICASSP2007, pp. I-13-1-16, April, 2007

### SUMMARY OF INVENTION

### Technical Problem

However, a conventional apparatus has a problem that, upon quantization of a balancing weight coefficient, the amount of calculation in balancing weight coefficient calculation and the amount of calculation in quantization become enormous. For example, although patent literature 1 discloses finding the ratio of sound volume between the left and the right and encoding that ratio, a complex arithmetic process of “division” is used to determine the ratio of sound volume, and this increases the amount of calculation.

It is therefore an object of the present invention to provide a quantizing apparatus, encoding apparatus, quantizing method and encoding method to reduce the amount of calculation in quantization of balancing weight coefficients and make possible more efficient quantization.

### Solution to Problem

A quantizing apparatus according to the present invention to quantize two coefficients to adjust an amplitude balance of a third signal acquired using a down mixing result of a first signal and a second signal, employs a configuration having: a power/correlation calculating section that receives as input three signals of the first signal, second signal, and third signal, calculates a first correlation value between the first signal and the third signal and a second correlation value between the second signal and the third signal, and calculates first power of the third signal; an intermediate value calculating section that calculates a first intermediate value using the first power, and calculates a second intermediate value using the first power and at least one of the first correlation value and the second correlation value; a codebook that stores a plurality of scalar values; and a search section that searches for a balancing weight coefficient to adjust the amplitude balance of the third signal with respect to the first signal based on the first intermediate value and the second intermediate value, out of the plurality of scalar values stored in the codebook, and acquires a code corresponding a scalar value searched out.

An encoding apparatus according to the present invention employs a configuration having: a down mixing section that receives as input and down mixes a first signal and a second signal, and generates a third signal using a down mixing result; a quantizing section that receives as input the first signal, the second signal and the third signal and outputs a code acquired by performing quantization with respect to two coefficients to adjust an amplitude balance of the third signal; a coefficient determining section that determines a first balancing weight coefficient to adjust the amplitude balance of the third signal with respect to the first signal using the code, and calculates a second balancing weight coefficient to adjust the amplitude balance of the third signal with respect to the second signal using the first balancing weight coefficient; and an encoding section that generates a first target signal using the first signal, the third signal and the first balancing weight coefficient, encodes the first target signal, generates a second target signal using the second signal, the third signal and the second balancing weight coefficient, and encodes the second target signal, in which the quantizing section comprises: a power/correlation calculating section that calculates a first correlation value between the first signal and the third signal and a second correlation value between the second signal and the third signal, and calculates first power of the third signal; an intermediate value calculating section that calculates a first intermediate value using the first power, and calculates a second intermediate value using the first power and at least one of the first correlation value and the second correlation value; a codebook that stores a plurality of scalar values; and a search section that searches for th first balancing weight coefficient out of the plurality of scalar values based on the first intermediate value and the second intermediate value, and acquires the code corresponding a scalar value searched out.

A quantizing method according to the present invention to quantize two coefficients to adjust an amplitude balance of a third signal acquired using a down mixing result of a first signal and a second signal, includes: a power/correlation calculating step of receiving as input three signals of the first signal, second signal, and third signal, calculating a first correlation value between the first signal and the third signal and a second correlation value between the second signal and the third signal, and calculating first power of the third signal; an intermediate value calculating step of calculating a first intermediate value using the first power, and calculating a second intermediate value using the first power and at least one of the first correlation value and the second correlation value; and a search step of searching for a balancing weight coefficient to adjust the amplitude balance of the third signal with respect to the first signal based on the first intermediate value and the second intermediate value, out of the plurality of scalar values stored in the codebook, and acquiring a code corresponding a scalar value searched out.

An encoding method according to the present invention includes: a down mixing step of receiving as input and down mixing a first signal and a second signal, and generating a third signal using a down mixing result; a quantizing step of receiving as input the first signal, the second signal and the third signal and outputting a code acquired by performing quantization with respect to two coefficients to adjust an amplitude balance of the third signal; a coefficient determining step of determining a first balancing weight coefficient to adjust the amplitude balance of the third signal with respect to the first signal using the code, and calculating a second balancing weight coefficient to adjust the amplitude balance of the third signal with respect to the second signal using the first balancing weight coefficient; and an encoding step of generating a first target signal using the first signal, the third signal and the first balancing weight, encoding the first target signal, generating a second target signal using the second signal, the third signal and the second balancing weight coefficient, and encoding the second target signal, in which the quantizing step comprises: a power/correlation calculating step of calculating a first correlation value between the first signal and the third signal and a second correlation value between the second signal and the third signal, and calculating first power of the third signal; an intermediate value calculating step of calculating a first intermediate value using the first power, and calculating a second intermediate value using the first power and at least one of the first correlation value and the second correlation value; and a search step of searching for the first balancing weight coefficient out of the plurality of scalar values based on the first intermediate value and the second intermediate value, and acquiring the code corresponding a scalar value searched out.

### Advantageous Effects of Invention

The present invention makes possible more efficient quantization of balancing weight coefficients.

### BRIEF DESCRIPTION OF DRAWINGS

FIG. 1 is a block diagram showing a configuration of an encoding apparatus according to embodiments 1 and 2 of the present invention;

FIG. 2 is a block diagram showing a configuration of a quantizing apparatus according to embodiments 1 and 2 of the present invention;

FIG. 3 shows, by way of example, scalar values numbered and stored in a codebook, according to embodiment 1 of the present invention; and

FIG. 4 shows part of information stored in a codebook, according to embodiment 3 of the present invention.

### DESCRIPTION OF EMBODIMENTS

Now, embodiments of the present invention will be described in detail with reference to the accompanying drawings.

### Embodiment 1

Configurations of the present invention for performing encoding and decoding using panning (hereinafter “balance adjustment”) will be explained using the following configuration.

That is to say, using part of the configuration of an encoder (that is, the configuration removing the part for generating side signals from the left half configuration shown in FIG. B.13) used widely as an AAC (Advanced Audio Codec), which is a standard MPEG-2 and MPEG-4 system in ISO/IEC given in “ISO/IEC 14496-3: 1999(E) “MPEG-2”, p. 232, FIG. B.13″ (hereinafter “non-patent literature 3), by adding intensity stereo components disclosed in patent literature 1 to the right half of this configuration and adding encoders to the respective output destinations of individual signals, an overall configuration for encoding and transmitting all information is given.

Furthermore, a stereo signal is designed so that, by receiving different audio signals in the left ear and the right ear, a listener can enjoy audio with realistic sensation. Consequently, with audio sigils to provide content, the simplest stereo signal is a two-channel signal comprised of an L signal and an R signal, and a case where an input signal is a two-channel signal will be described with the present embodiment.

First, the configuration of an encoding apparatus according to am embodiment of the present invention will be described.

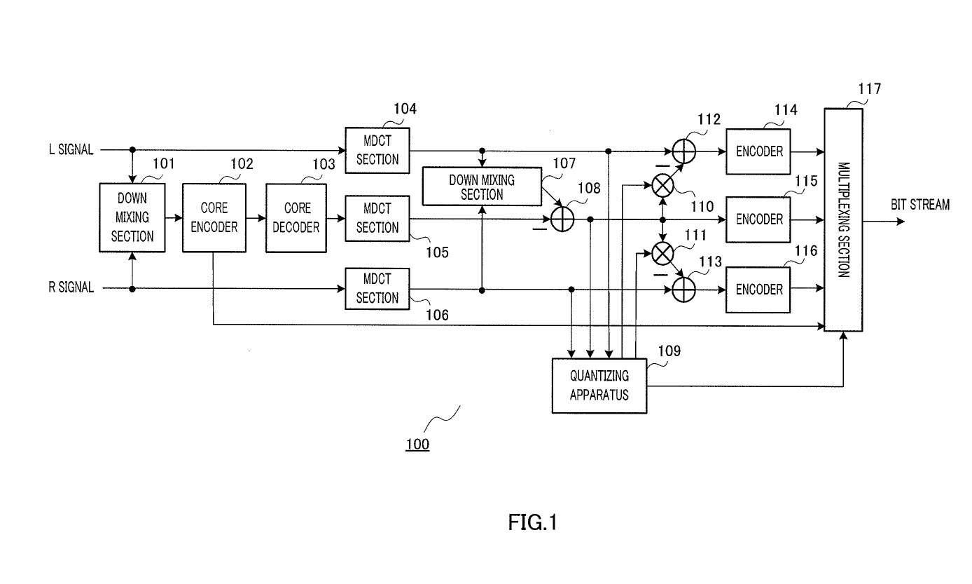

FIG. 1 is a block diagram showing a configuration of encoding apparatus 100 according to the present embodiment.

FIG. 1 shows a configuration to perform scalable (multilayer-structure) coding of stereo signals, that is, to encode an M signal in a core encoder and then encode a stereo signal in the frequency domain using a decoded signal generated by decoding in a core decoder.

Encoding apparatus 100 is formed primarily with down mixing section 101, core encoder 102, core decoder 103, modified discrete cosine transform (hereinafter referred to as “MDCT (Modified Discrete Cosine Transform)”) section 104, MDCT section 105, MDCT section 106, down mixing section 107, adding section 108, quantizing apparatus 109, multiplying section 110, multiplying section 111, adding section 112, adding section 113, encoder 114, encoder 115 and encoder 116.

Down mixing section 101 receives as input an L signal (first signal) and an R signal (second signal), which are vectors of a predetermined length, and provides an M signal (third signal) by down-mixing the L signal and R signal received as input. Down mixing section 101 also outputs the M signal found, to core encoder 102. Equation 1 is an example of a down mixing calculation method in down mixing section 101. The present embodiment uses a most simple down mixing method of adding an L signal and an R signal and multiplying the result by 0.5.

[1]

Mᵢ=(Lᵢ+Rᵢ)·0.5 (Equation 1)

where

i: index

Lᵢ: L signal

Rᵢ: signal

Mᵢ: signal

Core encoder 102 finds a code by encoding the M signal received as input from down mixing section 101, and outputs the found code to core decoder 103 and multiplexing section 117.

Core decoder 103 generates a decoded signal by decoding the code received as input from core encoder 102, and outputs the generated decoded signal to MDCT section 105.

MDCT section 104 receives as input the L signal, performs a discrete cosine transform of the L signal received as input, and transforms the time domain signal to a frequency domain signal (frequency spectrum). MDCT section 104 outputs the transformed signal to down mixing section 107, adding section 112 and quantizing apparatus 109.

MDCT section 105 performs a discrete cosine transform of the decoded signal received as input from core decoder 103, and transforms the time domain signal into a frequency domain signal (frequency spectrum). MDCT section 105 outputs the transformed signal to adding section 108.

MDCT section 106 receives as input an R signal, performs a discrete cosine transform of the R signal received as input, and transforms the time domain signal into a frequency domain signal (frequency spectrum). MDCT section 106 outputs the transformed signal to down mixing section 107, adding section 113 and quantizing apparatus 109.

Down mixing section 107 finds an M signal by down mixing the L signal received as input from MDCT section 104 and the R signal received as input from MDCT section 106. Down mixing section 107 outputs the found M signal to adding section 108. Down mixing section 107 is different from down mixing section 101 in down mixing a frequency domain signal, not a time domain signal. The down mixing calculation method is the same as equation 1 and will not be described here.

Adding section 108 subtracts the signal received as input from MDCT section 105, from the M signal received as input from down mixing section 107, and calculates an M signal of the target (hereinafter referred to as “target M signal”). Then, adding section 108 outputs the calculated target M signal to multiplying section 110, multiplying section 111, encoder 115 and quantizing apparatus 109.

Quantizing apparatus 109 encodes a balancing weight coefficient to use for balance adjustment and finds a weight coefficient code, using the L signal received as input from MDCT section 104, the target M signal received as input from adding section 108, and the R signal received as input from MDCT section 106. Then, quantizing apparatus 109 outputs the found code to multiplexing section 117. Quantizing apparatus 109 acquires balancing weight coefficient w_{L}, (hereinafter referred to as “L signal balancing weight coefficient w_{L}”) to adjust the amplitude balance of the target M signal with respect to the L signal by decoding found code, and sets acquired L signal balancing weight coefficient w_{L} in multiplying section 110. Quantizing apparatus 109 acquires balancing weight coefficient w_{R} (hereinafter referred to as “R signal balancing weight coefficient w_{R}”) to adjust the amplitude balance of the target M signal with respect to the R signal, using acquired L signal balancing weight coefficient w_{L}, and sets acquired R signal balancing weight coefficient w_{R} in multiplying section 111. The configuration of quantizing apparatus 109 will be described in detail later.

Multiplying section 110 multiples the target M signal received as input from adding section 108, by L signal balancing weight coefficient w_{L} received as input from quantizing apparatus 109, and outputs the result to adding section 112.

Multiplying section 111 multiplies the target M signal received as input from adding section 108, by R signal balancing weight coefficient w_{R} received as input from quantizing apparatus 109, and outputs the result to adding section 113.

Adding section 112 subtracts the target M signal multiplied by L signal balancing weight coefficient w_{L}, received as input from multiplying section 110, from the L signal received as input from MDCT section 104, and finds an L signal of the target (hereinafter “target L signal”). Adding section 112 outputs the found target L signal to encoder 114.

Adding section 113 subtracts the target M signal multiplied by R signal balancing weight coefficient w_{R}, received as input from multiplying section 111, from the R signal received as input from MDCT section 106, and finds an R signal of the target (hereinafter “target R signal”). Adding section 113 outputs the found target R signal to encoder 116. The calculations in adding section 112 and adding section 113 can be represented by equations 2.

[2]

\hat{L}_{f}=L_{f}−w_{L}·\hat{M}_{f}

\hat{R}_{f}=R_{f}−w_{R}·\hat{M}_{f} (Equations 2)

where

f: index

\hat{L}_{f}: target L signal

\hat{R}_{f}: target R signal

L_{f}: L signal

R_{f}: R signal

w_{L},w_{R}: decoded balancing weight coefficient

\hat{M}_{f}: target M signal

The above algorithms are equivalent to transformation of an L signal and an R signal using balance adjustment. The balancing weight coefficients show the similarity between the target M signal and the L and R signals. Consequently, a target L signal and a target R signal, given by subtracting the target M signal multiplied by balancing weight coefficients from an L signal and an R signal, become signals in which redundant parts are removed by the target M signal and in which signal power is reduced, so that the target L signal and target R signal both can be encoded efficiently.

Encoder 114 outputs a code found by encoding the target L signal received as input from adding section 112, to multiplexing section 117. Encoder 115 outputs a code found by encoding the target M signal received as input from adding section 108, to multiplexing section 117. Encoder 116 outputs a code found by encoding the target R signal received as input from adding section 113, to multiplexing section 117.

Multiplexing section 117 multiplexes the codes received as input from core encoder 102, quantizing apparatus 109, encoder 114, encoder 115 and encoder 116, and outputs a multiplexed bit stream.

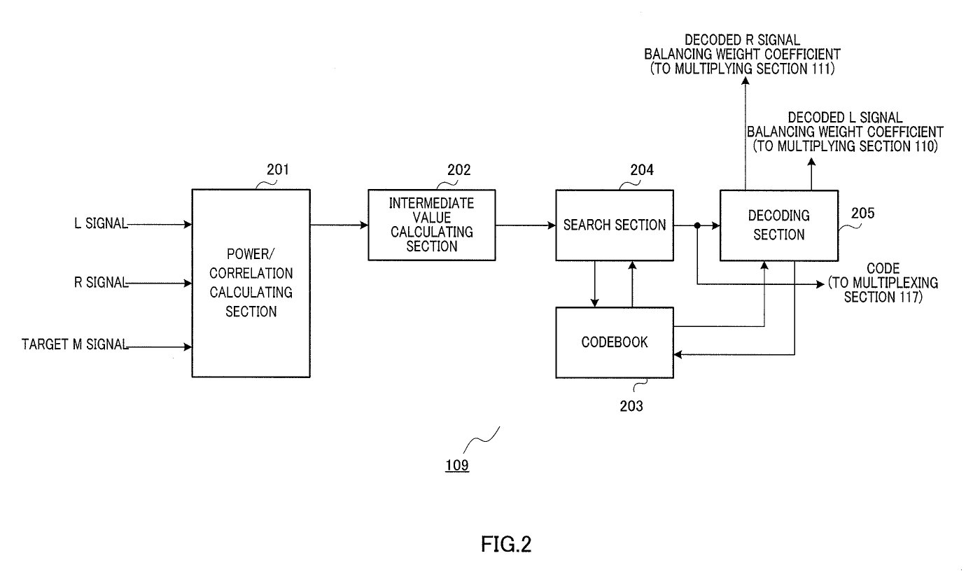

Next, the configuration of quantizing apparatus 109 will be described using FIG. 2. FIG. 2 is a block diagram showing a configuration of quantizing apparatus 109.

Quantizing apparatus 109 is formed primarily with power/correlation calculating section 201, intermediate value calculating section 202, codebook 203, search section 204 and decoding section 205.

Power/correlation calculating section 201 performs power calculation and correlation value calculation using the L signal received as input from MDCT section 104, the target M signal received as input from adding section 108, and the R signal received as input from MDCT section 106. Then, power/correlation calculating section 201 outputs the calculated power and correlation value, to intermediate value calculating section 202. The power and correlation value can be found by equations 3.

$$\begin{matrix}( Equations 3 ) & \\ {C}_{\hat{M} \hat{M}} = {\sum }_{f} {\hat{M}}_{f} \cdot {\hat{M}}_{f} \\ {C}_{\hat{M} L} = {\sum }_{f} {\hat{M}}_{f} \cdot {L}_{f} \\ {C}_{\hat{M} R} = {\sum }_{f} {\hat{M}}_{f} \cdot {R}_{f} & [ 3 ]\end{matrix}$$

where

C_{\hat{M}\hat{M}}: power of target M signal

C_{\hat{M}L}: correlation value between target M signal and L signal

C_{\hat{M}R}: correlation value between target M signal and R signal

Intermediate value calculating section 202 finds two intermediate values using the power and correlation value received as input from power/correlation calculating section 201. Then, intermediate value calculating section 202 outputs the found intermediate values to search section 204. For example, intermediate value can be determined using equations 4.

[4]

A₁=2.0·C_{\hat{M}\hat{M}}

A₂=−2.0·C_{\hat{M}L}−4.0·C_{\hat{M}M}+2.0.·C_{\hat{M}R} (Equations 4)

where A₁, A₂: intermediate values

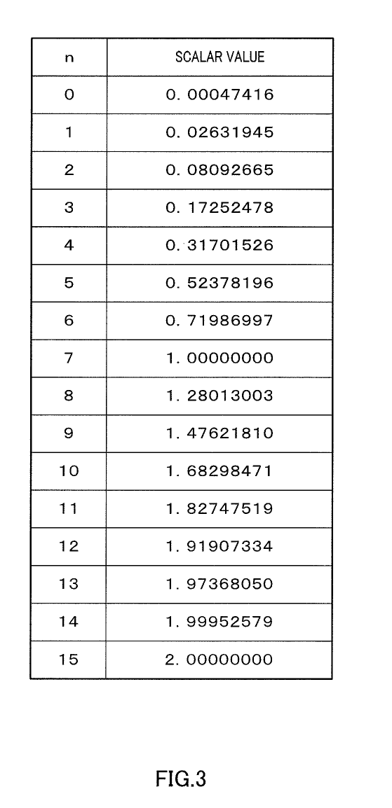

Codebook 203 is information that is stored in a memory means such as a ROM (Read Only Memory), and is formed with a plurality of scalar values to be selected as an L signal weight coefficient. FIG. 3 shows, by way of example, scalar values numbered and stored in codebook 203 of the present embodiment. The scalar values stored in codebook 203 are only the L values of balancing weight coefficients.

Search section 204 searches for an optimal one of a plurality of scalar values stored in codebook 203, and encodes a balancing weight coefficient by selecting a number corresponding to the optimal scalar value found. To be more specific, for example, search section 204 searches for number N to minimize the cost function shown in equation 5. Search section 204 outputs selected number N to multiplexing section 117 as a code. Search section 204 outputs the code having been outputted to multiplexing section 117, to decoding section 205.

[5]

A₁·(w_{L}ⁿ)²+A₂·w_{L}ⁿ (Equation 5)

where

w_{L}ⁿ: scalar value of number n stored in codebook 203

n: number (number N to minimize cost function becomes code)

Referring to equation 5, although scalar values stored in codebook 203 are squared, in this case, search is made possible by even a smaller amount of calculation by storing square values in codebook 203 in advance.

Decoding section 205 finds an L signal balancing weight coefficient by decoding a code (number N) received as input from search section 204 (w_{L}=w_{L}^{N}). That is to say, decoding section 205 picks up a scalar value corresponding to the code (number N) received as input from search section 204, out of a plurality of scalar values stored in codebook 203, as an L signal balancing weight coefficient.

Decoding section 205 uses the result of subtracting the acquired L signal balancing weight coefficient from a predetermined constant, as an R signal balancing weight coefficient. For example, decoding section 205 finds an R signal balancing weight coefficient (w_{R}=2.0−w_{L}^{N}) by subtracting the L signal balancing weight coefficient from the constant 2.0. Here N is an L signal balancing weight coefficient code, and w_{L} and w_{R} are decoded balancing weight coefficients. The constant 2.0 is a value set according to the quantitative relationships between signals upon down mixing in down mixing section 101. The reason to find an R signal balancing weight coefficient by subtracting an L signal balancing weight coefficient from the constant 2.0, will be described later.

Decoding section 205 sets the L signal balancing weight coefficient in multiplying section 110 and sets the R signal balancing weight coefficient in multiplying section 111.

Next, a detailed explanation will be given about the theoretical background of balance adjustment by means of quantized and decoded balancing weight coefficients according to the present invention.

First, efficient coding of an L signal and R signal using balance adjustment is made possible by minimizing the power of the transformed values in equations 6. The M signal in this case is an average value of an L signal and an R signal.

$$\begin{matrix}( Equations 6 ) & \\ {E}_{L} = {\sum }_{f} {L}_{f}^{′2} \\ {E}_{R} = {\sum }_{f} {R}_{f}^{′2} & [ 6 ]\end{matrix}$$

where L′_{f} and R′_{f} in equation 6 are the same as shown in equation 7

[7]

L′_{f}=L_{f}−w_{L}·M_{f}

R′_{f}=R_{f}−w_{R}·M_{f} (Equations 7)

Next, calculating a balancing weight coefficient to minimize the L signal power in equations 6 gives equation 8.

$$\begin{matrix}( Equation 8 ) & \\ \frac{\partial {E}_{L}}{\partial {w}_{L}} = {\sum }_{f} {M}_{f} \cdot {L}_{f} - {w}_{L} \cdot {\sum }_{f} {M}_{f} \cdot {M}_{f} = 0 \\ ∴ {w}_{L} = \frac{{C}_{ML}}{{C}_{MM}} \\ ( ∵ {\sum }_{f} {M}_{f} \cdot {L}_{f} = {C}_{ML} , {\sum }_{f} {M}_{f} \cdot {M}_{f} = {C}_{MM} ) & [ 8 ]\end{matrix}$$

Similarly, in equations 6, the balancing weight coefficient to minimize the power in the equation for the R signal is shown as equation 9.

$$\begin{matrix}( Equation 9 ) & \\ {w}_{R} = \frac{{C}_{MR}}{{C}_{MM}} & [ 9 ]\end{matrix}$$

That is to say, L signal power and R signal power can be minimized by selecting the balancing weight coefficients of equations 8 and 9 above.

Furthermore, given that the M signal holds the relationship of equation 1, the addition result of an L signal balancing weight coefficient and an R signal balancing weight coefficient can be represented by equation 10, from equation 1 and equations 3.

$$\begin{matrix}( Equation 10 ) & \\ {w}_{L} + {w}_{R} = \frac{{C}_{ML} + {C}_{MR}}{{C}_{MM}} = \frac{2.0 \cdot {C}_{MM}}{{C}_{MM}} = 2.0 & [ 10 ]\end{matrix}$$

Although with the present embodiment a target M signal is quantized in a scalable fashion as shown in FIG. 1, not based on the simple relationship of equation 1, but, presuming that the relationship of equation 1 is predominant, balancing weight coefficients are quantized based on the relationship of equation 10. Based on this presumption, it is possible to quantize (encode) only one parameter, allowing low bit rate coding.

Furthermore, it is also possible to quantize L signal balancing weight coefficient w_{L} alone using codebook 203, and find R signal balancing weight coefficient w_{R} from the relationship of equation 10. Cost function F of search in this case can be represented by equation 11.

$$\begin{matrix}( Equation 11 ) & \\ \begin{matrix}F = {\sum }_{f} {( {w}_{L} \cdot {\hat{M}}_{f} - {L}_{f} )}^{2} + {\sum }_{f} {\{ ( 2.0 - {w}_{L} ) \cdot {\hat{M}}_{f} - {R}_{f} \}}^{2} \\ = 2.0 \cdot {C}_{\hat{M} \hat{M}} \cdot {w}_{L}^{2} + \\ ( - 2.0 \cdot {C}_{\hat{M} L} - 4.0 \cdot {C}_{\hat{M} \hat{M}} + 2.0 \cdot {C}_{\hat{M} R} ) \cdot {w}_{L} + \\ ( {C}_{LL} + 4.0 \cdot {C}_{\hat{M} \hat{M}} - 4.0 \cdot {C}_{\hat{M} R} + {C}_{RR} )\end{matrix} & [ 11 ]\end{matrix}$$

In above equation 11, the third term is not related to L signal balancing weight coefficient w_{L} and therefore omitted, and only the sum of the first term and the second term is used as a cost function. The values multiplied upon the balancing weight coefficients are the two intermediate values shown in equations 4. Furthermore, when this cost function is smaller, the total sum of a target L signal and a target R signal can be made smaller, and searching for such L signal balancing weight coefficient w_{L} is equivalent to quantizing (encoding) an optimal balancing weight coefficient.

By using balancing weight coefficients found by means of the above coding, it is possible to reduce target L signal power and target R signal power and consequently transmit sound/speech of good quality at low bit rates.

A verification test of the present embodiment has been conducted and its result will be explained next. The encoder that was used was a codec simulator to perform the same scalable spectrum quantization of stereo signals (16 kHz sampling) as in non-patent literature 3. The evaluation data was data (24 seconds) appending six sounds/voices given from varying source positions. The number of balancing weight coefficient quantization bits was four.

The result of performing a verification test based on the above conditions was that, by replacing a conventional encoding apparatus with the encoding apparatus of the present embodiment, the amount of calculation when finding balancing weight coefficients according to the present embodiment and performing quantization was 3/5 compared to heretofore. Consequently, with the present embodiment, the amount of calculation was saved significantly compared to heretofore.

Reasons this significant effect could be achieved may include that a calculation to involve a complex arithmetic operation and increase the amount of calculation, such as division, is not performed, and that the number of pairs of numbers and scalar values stored in codebook 203 is comparatively small, that is, sixteen variations, so that these can be specified by only dour bits.

Thus, with the present invention, balancing weight coefficients themselves are not calculated, so that the amount of calculation is reduced and more efficient quantization is made possible.

### Embodiment 2

A feature of the present embodiment lies in performing different calculations from embodiment 1 in a quantizing apparatus upon performing coding and decoding using balance adjustment. With the present embodiment, the encoding apparatus configuration is the same as in FIG. 1 and explanations will be omitted. Also, with the present embodiment, the quantizing apparatus configuration is the same as in FIG. 2. In the following description, codes in FIG. 1 and FIG. 2 will be used.

Power/correlation calculating section 201 performs power calculation and correlation value calculation using the L signal received as input from MDCT section 104, the target M signal received as input from adding section 108, and the R signal received as input from MDCT section 106. Power/correlation calculating section 201 outputs the calculated power and correlation value to intermediate value calculating section 202. Power/correlation calculating section 201 finds power and correlation value by equations 12.

$$\begin{matrix}( Equations 12 ) & \\ C {1}_{\hat{M} \hat{M}} = {\sum }_{f} {\hat{M}}_{f} \cdot {\hat{M}}_{f} + γ \cdot {C}_{LLRR} \\ C {1}_{\hat{M} L} = {\sum }_{f} {\hat{M}}_{f} \cdot {L}_{f} + η \cdot {C}_{LL} \\ C {1}_{\hat{M} R} = {\sum }_{f} {\hat{M}}_{f} \cdot {R}_{f} + ζ \cdot {C}_{RR} \\ {C}_{LL} = {\sum }_{f} {L}_{f} \cdot {L}_{f} \\ {C}_{RR} = {\sum }_{f} {R}_{f} \cdot {R}_{f} \\ {C}_{LLRR} = {C}_{LL} + {C}_{RR} & [ 12 ]\end{matrix}$$

where

C1_{\hat{M}\hat{M}}: adjusted power of target M signal

C1_{\hat{M}L}: adjusted correlation value of target M signal and L signal

C1_{\hat{M}R}: adjusted correlation value of target M signal and R signal

C_{LL}: power of L signal

C_{RR}: power of R signal

C_{LLRR}: sum of L signal power and R signal power

γ,η,ζ: proportion to add power components (coefficients)

In equations 12, γ, η, and ζ, representing the proportions of power components to be added, may be variables or constants, or may be all different values. For example, experiment has shown that, when making γ, η, and ζ constants, good performance can be achieved by setting these three γ, η, and ζ to 0.25.

The adjusted power of a target M signal, the adjusted correlation value of a target M signal and an L signal, and the adjusted correlation value of a target M signal and an R signal, are provided by adjusting the power of a target M signal, the correlation value of a target M signal and an L signal, and the correlation value of a target M signal and an R signal using the power of an L signal, the power of an R signal, the sum of L signal power and R signal power, and the proportions of power components to be added (three coefficients). In the following description, the adjusted power of a target M signal will be redefined as the power of a target M signal, the adjusted correlation value of a target M signal and an L signal will be redefined as the correlation value between a target M signal and an L signal, and the adjusted correlation value of a target M signal and an R signal will be redefined as the correlation value of a target M signal and an R signal.

When γ, η and ζ are made variables, power/correlation calculating section 201 performs equalization in order to reduce the variations of the variables over time. Power/correlation calculating section 201 performs equalization by performing the calculation of equations 13, applying the result to equations 14, and updating each state.

[13]

C2_{\hat{M}\hat{M}}=α·C_{\hat{M}\hat{M}}+(1−α)·S_{\hat{M}\hat{M}}

C2_{\hat{M}L}=α·C_{\hat{M}L}+(1−α)·S_{\hat{M}L}

C2_{\hat{M}R}=α·C_{\hat{M}R}+(1−α)·S_{\hat{M}R} (Equations 13)

where

C2_{\hat{M}\hat{M}}: equalized power of target M signal

C2_{\hat{M}L}: equalized correlation value between target M signal and L signal

C2_{\hat{M}R}: equalized correlation value between target M signal and R signal

S_{\hat{M}\hat{M}}: power state of target M signal

S_{\hat{M}L}: correlation value state between target M signal and L signal

S_{\hat{M}R}: correlation value state between target M signal and R signal

α: proportion in equalization

[14]

S_{\hat{M}\hat{M}}=C2_{\hat{M}\hat{M}}

S_{\hat{M}L}=C2_{\hat{M}L}

S_{\hat{M}R}=C2_{\hat{M}R} (Equation 14)

where

C2_{\hat{M}\hat{M}}: equalized power of target M signal

C2_{\hat{M}L}: equalized correlation value between target M signal and L signal

C2_{\hat{M}R}: equalized correlation value between target M signal and R signal

S_{\hat{M}\hat{M}}: power state of target M signal

S_{\hat{M}L}: correlation value state between target M signal and L signal

S_{\hat{M}R}: correlation value between target M signal and R signal

The three states in equations 13 and equations 14, namely the power state of a target M signal, the correlation state of a target M signal and an L signal, and the correlation state of a target M signal and an R signal, are all variables to be stored in a static memory area during coding processing. Consequently, upon starting coding processing, the three states need to be initialized to 0. Furthermore, α, which represents the proportion in equalization, may be either a variable or a constant. For example, experiment has shown that good performance can be achieved when α is set between 0.5 and 0.7. When α is 1.0, power/correlation calculating section 201 performs equalization.

The equalized power of a target M signal, the equalized correlation value of a target M signal and an L signal, and the equalized correlation value of a target M signal and an R signal, are provided by equalizing the power of a target M signal, the correlation value of a target M signal and an L signal, and the correlation value of a target M signal and an R signal, using the power state of a target M signal, the correlation value state of a target M signal and an L signal, the correlation value state of a target M signal and an R signal and the proportions of equalization. In the following descriptions, the equalized power of a target M signal will be redefined as the power of a target M signal, the equalized correlation value of a target M signal and an L signal will be redefined as a correlation value of a target M signal and an L signal, and the equalized correlation value of a target signal and an R signal will be redefined as the correlation value of a target M signal and an R signal.

With the present embodiment, the processings in intermediate value calculating section 202, codebook 203, search section 204 and decoding section 205 are the same as in embodiment 1, and so their explanations will be omitted.

The present embodiment is different from embodiment 1 in adding L signal power or R signal power in equations 12. An effect of adding L signal power or R signal power will be explained below.

First, the cost function is as shown in equation 11. ω_{L} to minimize this cost function is as shown in equation 15, given that the result of partial differentiation is 0.

$$\begin{matrix}( Equation 15 ) & \\ {w}_{L} = \frac{2.0 \cdot ( {C}_{LL} + {C}_{LR} )}{( {C}_{LL} + 2.0 \cdot {C}_{LR} + {C}_{RR} )} & [ 15 ]\end{matrix}$$

In equation 15, when cross term C_{LR} shows stable positive correlation (that is, has a positive value), ω_{L} is a stable weight and gives little perceptual awkwardness. On the other hand, when cross term C_{LR} shows negative correlation or moves wildly between positive and negative over time, although cost function F is made smaller, decoded sound/speech obtained in a decoder using that weight is perceptually awkward sound/speech in which sound pressure moves to the left and the right wildly. This is a specific phenomenon seen when there is significant coding distortion.

Then, in quantization of weight, if the cost function is modified in a direction to be less influenced by the value of cross term C_{LR}, it is possible to achieve good sound/speech quality even when there is significant coding distortion.

If each term in equations 4 is developed top be in proximity with a signal given by down mixing a target M signal, the result can be represented by equations 16.

A₁=2.0·C_{\hat{M}\hat{M}}≅0.5·(C_{LLRR}+2.0·C_{LR})

A₂=−2.0·C_{\hat{M}L}−4.0·C_{\hat{M}M}+2.0·C_{\hat{M}}≅(C_{LL}+C_{LR})−(C_{LLRR}+2.0·C_{LR})+(C_{RR}+C_{LR}) (Equations 16)

To reduce the influence of cross term C_{LR} included in each term of equations 16, the values of the terms of power besides cross term C_{LR} may be added and increased. This is a significant element of the present embodiment. Consequently, in the end, equations 12 can be derived. Experiment has verified that good sound/speech quality can be achieved when the transmission rate is low (that is, when there is significant coding distortion).

In equations 12, addition of the values of the terms of power besides cross term C_{LR} is addition of known signal power, so that the amount of calculation required for weight quantization does not increase significantly. Consequently, a significant effect can be achieved at a small increase in the amount of calculation.

According to the present embodiment, in addition to the advantages of above embodiment 1, by reducing the influence of cross term between a plurality of signals, it is possible to achieve good sound/speech quality by preventing awkward sound/speech quality in which, for example, sound pressure varies significantly, prevent the amount of calculation from increasing, and achieve good sound/speech quality.

### Embodiment 3

A feature of the present embodiment lies in performing different calculations from those of embodiment 1 and embodiment 2, in a quantizing apparatus, upon performing coding and decoding using balance adjustment. The encoding apparatus configuration of the present embodiment is the same as in FIG. 1, and its explanations will be omitted. With the present embodiment, the quantizing apparatus configuration is the same as in FIG. 2. In the following description of a quantizing apparatus, codes in FIG. 1 and FIG. 2 will be used.

Power/correlation calculating section 201 performs power calculation and correlation value calculation using the L signal received as input from MDCT section 104, the target M signal received as input from adding section 108, and the R signal received as input from MDCT section 106. Power/correlation calculating section 201 outputs the calculated power and correlation value, to intermediate value calculating section 202. Power/correlation calculating section 201 finds the power and correlation value using equations 12 and equations 17. Equations 17 provides an algorithm to support embodiment 1 and equations 12 provides an algorithm to support embodiment 2.

$$\begin{matrix}( Equations 17 ) & \\ {C}_{\hat{M} \hat{M}} = {\sum }_{f} {\hat{M}}_{f} \cdot {\hat{M}}_{f} \\ {C}_{\hat{M} L} = {\sum }_{f} {\hat{M}}_{f} \cdot {L}_{f} \\ {C}_{\hat{M} R} = {\sum }_{f} {\hat{M}}_{f} \cdot {R}_{f} \\ {C}_{LL} = {\sum }_{f} {L}_{j} \cdot {L}_{f} \\ {C}_{RR} = {\sum }_{f} {R}_{f} \cdot {R}_{f} & [ 17 ]\end{matrix}$$

where

C_{\hat{M}\hat{M}}: power of target M signal

C_{\hat{M}L}: correlation value between target M signal and L signal

C_{\hat{M}R}: correlation value between target M signal and R signal

C_{LL}: power of L signal

C_{RR}: power of R signal

When power and correlation value are found using equations 12, power/correlation calculating section 201 performs equalization as represented by equations 13 and equations 14 in order to reduce the variations of variables in equations 12 over time. When power and correlation value are found using equations 17, power/correlation calculating section 201 performs equalization by performing the calculation of equations 18, applying the result of equations 18 to equations 19 and updating each state.

[18]

C3_{\hat{M}\hat{M}}=α·C_{\hat{M}\hat{M}}+(1−α)−S_{\hat{M}\hat{M}}

C3_{\hat{M}L}=α·C_{\hat{M}L}+(1−α)−S_{\hat{M}L}

C3_{\hat{M}R}=α·C_{\hat{M}R}+(1−α)−S_{\hat{M}R}

C3_{LL}=α·C_{LL}+(1−α)−S_{LL}

C3_{RR}=α·C_{RR}+(1−α)−S_{RR} (Equations 18)

where

C3_{\hat{M}\hat{M}}: equalized power of target M signal

C3_{\hat{M}L}: equalized correlation value between target M sign al and L signal

C3_{\hat{M}R}: equalized correlation value between target M sign al and R signal

C3_{LL}: equalized power of L signal

C3_{RR}: equalized power of R signal

S_{\hat{M}\hat{M}}: equalized power of target M signal

S_{\hat{M}L}: correlation value state between target M signal an d L signal

S_{\hat{M}R}: correlation value state between target M signal an d R signal

S_{LL}: power state of L signal

S_{RR}: power state of R signal

α: proportion in equalization

[19]

S_{\hat{M}\hat{M}}=C3_{\hat{M}\hat{M}}

S_{\hat{M}L}=C3_{\hat{M}L}

S_{\hat{M}R}=C3_{\hat{M}R}

S_{LL}=C3_{LL}

S_{RR}=C3_{RR} (Equations 19)

where

C3_{\hat{M}\hat{M}}: equalized power of target M signal

C3_{\hat{M}L}: equalized correlation value of target M signal and L signal

C3_{\hat{M}R}: equalized correlation value of target M signal and R signal

C3_{LL}: equalized power of L signal

C3_{RR}: equalized power of R signal

S_{\hat{M}\hat{M}}: power state of target M signal

S_{\hat{M}L}: correlate values state between target M signal an d L signal

S_{\hat{M}R}: correlation value state between target M signal an d R signal

S_{LL}: power state of L signal

S_{RR}: power state of R signal

The equalized power of a target M signal, the equalized correlation value of a target M signal and an L signal, and the equalized correlation value of a target M signal and an R signal, are provided by equalizing the power of a target M signal, the correlation value of a target M signal and an L signal, and the correlation value of a target M signal and an R signal, using the power state of a target M signal, the correlation value state of a target M signal and an L signal, the correlation value state of a target M signal and an R signal and the proportions of equalization. In the following descriptions, the equalized power of a target M signal will be redefined as the power of a target M signal, the equalized correlation value of a target M signal and an L signal will be redefined as a correlation value of a target M signal and an L signal, the equalized correlation value of a target signal and an R signal will be redefined as the correlation value of a target M signal and an R signal, the equalized power of an L signal will be redefined as the power of an L signal, and the equalized power of an R signal will be redefined as the power of an R signal.

Intermediate value calculating section 202 finds five intermediate values using the power and correlation value received as input from power/correlation calculating section 201. Intermediate value calculating section 202 outputs the found intermediate values to search section 204. For example, intermediate values can be found using equations 20.

[20]

α₀=C_{\hat{M}\hat{M}}

α₁=−2.0·C_{\hat{M}L}

α₂=−4.0·C_{\hat{M}\hat{M}}+2.0·C_{\hat{M}R}

α₃=C_{LL}

α₄=4.0·C_{\hat{M}\hat{M}}−4.0·C_{\hat{M}R}+C_{RR} (Equations 20)

where α₀, α₁, α₂,α₃,α₄: intermediate values

Codebook 203 is information that is stored in a memory means such as a ROM and is formed with a plurality of scalar values to be selected as an L signal balancing weight coefficient, weight coefficients, and calculated value found from weigh coefficients. The content of information to be stored in codebook 203 will be described later.

Search section 204 searches for an optimal one of a plurality of scalar values stored in codebook 203, and encodes a balancing weight coefficient by selecting a number corresponding to the optimal scalar value found. To be more specific, for example, search section 204 searches for number N to minimize the cost function shown in equation 21. Search section 204 outputs selected number N to multiplexing section 117 as a code. Search section 204 outputs the code having been outputted to multiplexing section 117, to decoding section 205. The processing in decoding section 205 according to the present embodiment is the same as in above embodiment 1 and so will not be described.

[21]

α₀·w₀ⁿ+α₁·w₁ⁿα₂·w₂ⁿ+α₃·ω_{L}ⁿ+α4·ω_{R}ⁿ (Equation 21)

where ω_{L}ⁿ,ω_{R}ⁿ: scalar values of number n stored in codebook 203 (weight coefficients for L signal and R signal)

w₀ⁿ,w₁ⁿ,w₂ⁿ: values determined using scalar value of nu mber n stored in codebook 203 (balancing weight coefficient f or L signal) and weight coefficients for L signal and R signal

n: number (number N to minimize cost function beco mes code)

This concludes the explanation of the configuration of quantizing apparatus 109.

The idea of the present embodiment and the method of designing codebook 203 of the present embodiment will be explained next.

Although the theoretical background of balance adjustment is the same as described with embodiment 1, the cost function of the present embodiment is different from those of embodiment 1 and embodiment 2. Although embodiment 1 and embodiment 2 use the cost function of equation 11, when the cost function of equation 11 is used, good sound/speech quality can be achieved when there is not much difference between the power of signal L_{f} and the power of signal R_{f}, but, when there is a significant difference between the power of signal L_{f} and the power of signal R_{f} (that is, when balancing weight coefficient wⁿ_{L} is extremely small or when balancing weight coefficient wⁿ_{L} is extremely large), the one of the L signal side and the R signal side having the greater power becomes predominant, and the one of the smaller power becomes not worth evaluating. In that case, a phenomenon occurs where the signal of the one of the smaller power becomes even smaller. In embodiment 1 and embodiment 2, the distortion of the signal of the smaller power becomes smaller, so that the sound/speech quality of the predominant signal improves and good sound/speech quality can be achieved. There is also a method to keep the power of a signal of a small sound that is heard with a big sound from falling, and, in that case, ingenuity would be required. So, the present embodiment uses the cost function of equation 22 below.

$$\begin{matrix}( Equation 22 ) & \\ F = {ω}_{L} {\sum }_{f} {( {w}_{L} \cdot {\hat{M}}_{f} - {L}_{f} )}^{2} + {ω}_{R} {\sum }_{f} {\{ ( 2.0 - {w}_{L} ) \cdot {\hat{M}}_{f} - {R}_{f} \}}^{2} & [ 22 ]\end{matrix}$$

where ω_{L},ω_{R}: weight coefficients for L signal and R signal

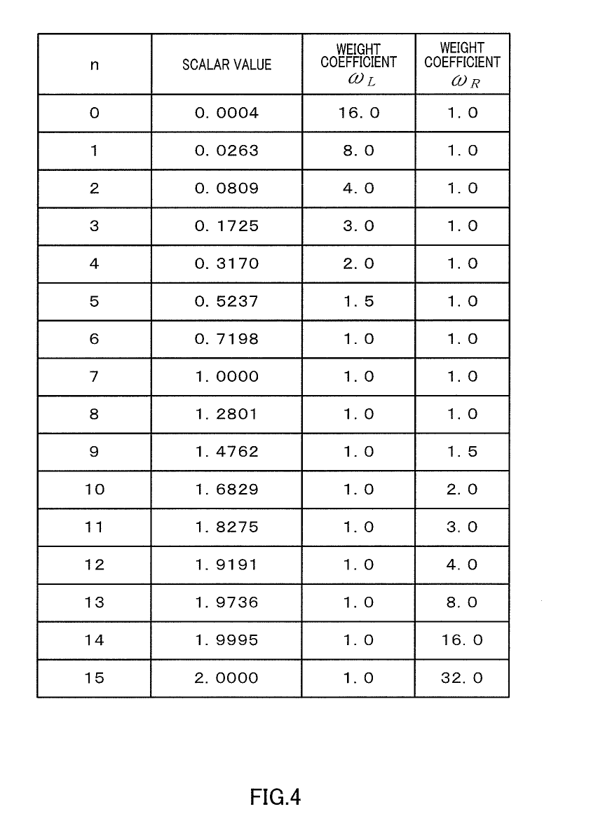

That is to say, the difference between L signal power and R signal power can be learned from the scale of the reconstructed L signal balancing weight coefficient, so that the above technical problems can be solved by performing weighting of the corresponding cost function. The present embodiment uses the weight coefficients shown in FIG. 4. FIG. 4 shows part of information stored in codebook 203 of the present embodiment. In FIG. 4, the size of codebook 203 is 16 (four bits).

As obvious from FIG. 4, when the value of L signal weight coefficient ω_{L} is small, the value of R signal weight coefficient ω_{R} is set large, and, when the value of R signal weight coefficient ω_{R} is small, the value of L signal weight coefficient ω_{L} is set large. By this means, the weight of the cost function of equation 22 can be adjusted.

Now, the intermediate values are found by developing the cost function of equation 22. The developed equations are shown as equation 23.

$$\begin{matrix}( Equation 23 ) & \\ \begin{matrix}F = {ω}_{L} {\sum }_{f} {( {w}_{L} \cdot {\hat{M}}_{f} - {L}_{f} )}^{2} + {ω}_{R} {\sum }_{f} {\{ ( 2.0 - {w}_{L} ) \cdot {\hat{M}}_{f} - {R}_{f} \}}^{2} \\ = ( {ω}_{L} + {ω}_{R} ) \cdot {C}_{\hat{M} \hat{M}} \cdot {w}_{L}^{2} + \\ ( - 2.0 {ω}_{L} \cdot {C}_{\hat{M} L} - 4.0 {ω}_{R} \cdot {C}_{\hat{M} \hat{M}} + 2.0 {ω}_{R} \cdot {C}_{\hat{M} R} ) \cdot {w}_{L} + \\ ( {ω}_{L} \cdot {C}_{LL} + 4.0 {ω}_{R} \cdot {C}_{\hat{M} \hat{M}} - 4.0 {ω}_{R} \cdot {C}_{\hat{M} R} + {ω}_{R} \cdot {C}_{RR} )\end{matrix} & [ 23 ]\end{matrix}$$

In equation 21, calculated values wⁿ₀, wⁿ₁, and wⁿ₂, necessary for the calculation of equation 21, are found in advance by equations 24 below, and stored in codebook 203.

[24]

w₀ⁿ=(ω_{L}+ω_{R})·w_{L}²

w₁ⁿ=ω_{L}·w_{L}

w₂ⁿ=ω_{R}·w_{L} (Equations 24)

Thus, according to the present embodiment, it is possible to find intermediate values by equation 20, find scalar values efficiently following the above steps using codebook 203 and equation 21, and quantize balancing weight coefficients. As a result of this, even when there is a significant difference between the values of the two terms of the L signal side and the R signal side constituting the cost function, the deterioration of the signal of the smaller value, caused by the fact that the term of the greater value becomes predominant, can be prevented, and, consequently, synthesized speech of good overall sound/speech quality can be acquired.

Although with the present embodiment the size of the codebook is sixteen variations (four bits), the present invention is by no means limited to this, and other sizes can obviously be used as well, because the present invention does not rely upon the size of the codebook.

Although examples have been given with above embodiments 1 through embodiment 3 where coding is performed in a scalable configuration in which an M signal is encoded in core encoder 102 before a stereo signal is quantized, the present invention is by no means limited to this and is equally applicable to stereo signal coding without a core encoder. This is because the present invention is designed to encode a balancing weight coefficient efficiently taking advantage of the fact that an M signal is produced by down mixing, and because the present invention therefore does not rely upon the presence or absence of a core encoder.

Regarding the M signal to be processed in quantizing apparatus 109, although the difference between an M signal acquired by down mixing and a decoded signal obtained by core decoder 103 is used as a target M signal, the present invention is not limited to this, and it is equally possible to process a decoded signal or an M signal subjected to down mixing, in quantizing apparatus 109. This is because the present invention is designed to encode a balancing weight coefficient efficiently taking advantage of the fact that an M signal is produced by down mixing, and because the present invention therefore does not rely upon the quality of an M signal.

Although embodiment 1 to embodiment 3 above disclose cases where the sum of the balancing weight coefficients of an L signal and an R signal is 2.0, the present invention is by no means limited to this, and the sum of the balancing weight coefficients of an L signal and an R signal may be values other than 2.0, such as 1.9, 1.85, etc., given that the optimal value might vary depending on the nature of an M signal. A possible interpretation of the present embodiment is that some of the characteristics of an M signal are lost, due to down minimizing, from a target M signal obtained in core encoder 102, so that there is a possibility to achieve good coding performance by setting values slightly lower than 2.0. To be more specific, a possible method is to, for example, evaluate coding performance by changing this sum value little by little and using this sum value as the value of the sum of the balancing weight coefficients of an L signal and an R signal for encoding, on a fixed basis.

Although with embodiment 1 to embodiment 3 above down mixing is performed after transformation into the frequency domain, the present invention is by no means limited to this, and the present invention obviously maintains valid even if a signal having been down mixed in the time domain is transformed into the frequency domain, because the present invention does not rely upon in which domain down mixing is performed.

Although in embodiment 1 through embodiment 3 above the MDCT is used as the method of transformation into the frequency domain, the present invention is by no means limited to this, and it is equally possible to use any digital transformation method resembling the MDCT such as the DCT and FFT, because the present invention does not rely upon the method of frequency domain transformation.

Although the three signals in embodiments 1 to embodiment 3 above were time domain signals, it is equally possible to use frequency domain signals or segments of these signals, because the present invention does not rely upon the nature of vectors.

Codes acquired in embodiment 1 to embodiment 3 above may be transmitted when used for communication or may be stored in a recoding medium (such as a memory, disc or print code) when used for storage, because the present invention does not rely upon the usage of codes.

Although cases with two channels have been described above with embodiments 1 to embodiment 3, the present invention is by no means limited to this and is equally applicable to cases of multiple channels (e.g. 5.1 ch).

Although with embodiment 1 to embodiment 3 above an L signal, R signal and M signal are subject to coding, the present invention is by no means limited to this, and it is equally possible to encode frequency spectrums of an L signal, R signal, and M signal, or segments of these, as a first signal, second signal and third signal.

Although with embodiment 1 to embodiment 3 above balance adjustment for a target M signal is performed prior to encoding, the present invention is by no means limited to this, and it is equally possible to perform encoding prior to balance adjustment. That is to say, encoder 115 may be placed in a location closer to input than adding section 108, because the present invention does not rely upon whether balance adjustment is performed before or after encoding.

Although the above descriptions have shown preferred embodiments of the present invention by way of example, this by no means limits the scope of the present invention. The present invention is applicable to any system featuring a coding apparatus.

The quantizing apparatus and encoding apparatus according to the present invention can be provided in a communication terminal apparatus and base station apparatus in a mobile communication system, so that it is possible to provide a communication terminal apparatus, base station apparatus and a mobile communication system having the same operations and effects.

Also, although cases have been described with the above embodiment as examples where the present invention is configured by hardware, the present invention can also be realized by software. For example, it is possible to write the algorithms of the present invention in a programming language, store this program in a memory, and, by running this program using an information processing means, implement the same functions as those of the coding apparatus of the present invention.

Each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI,” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese patent application No. 2008-205643, filed Aug. 8, 2008, Japanese patent application No. 2009-59502, filed Mar. 12, 2009, and Japanese patent application No. 2009-95260, filed Apr. 9, 2009, including the specifications, drawings and abstracts, are incorporated herein by reference in their entirety.

### INDUSTRIAL APPLICABILITY

The quantizing apparatus, encoding apparatus, quantizing method and encoding method of the present invention are suitable for use to, for example, encode a stereo audio signal at a low bit rate.

1. A quantizing apparatus to quantize two coefficients to adjust an amplitude balance of a third signal acquired using a down mixing result of a first signal and a second signal, the quantizing apparatus comprising:
a power/correlation calculating section that receives as input three signals of the first signal, second signal, and third signal, calculates a first correlation value between the first signal and the third signal and a second correlation value between the second signal and the third signal, and calculates first power of the third signal;
an intermediate value calculating section that calculates a first intermediate value using the first power, and calculates a second intermediate value using the first power and at least one of the first correlation value and the second correlation value;
a codebook that stores a plurality of scalar values; and
a search section that searches for a balancing weight coefficient to adjust the amplitude balance of the third signal with respect to the first signal based on the first intermediate value and the second intermediate value, out of the plurality of scalar values stored in the codebook, and acquires a code corresponding a scalar value searched out.

2. The quantizing apparatus according to claim 1, wherein the intermediate value calculating section calculates the second intermediate value using the first power, the first correlation value, and the second correlation value.

3. The quantizing apparatus according to claim 1, wherein the search section searches for the code corresponding to a scalar value to minimize a value obtained by applying the plurality of scalar values to an equation set by using the first intermediate value and the second intermediate value.

4. The quantizing apparatus according to claim 1 wherein:
the power/correlation calculating section calculates second power of the first signal and third power of the second signal, calculates a fourth signal using the second power and the third power, calculates first adjusted power adjusting the first power using the fourth signal and the predetermined first power adjusting coefficient, and calculates a first adjusted correlation value adjusting the first correlation value using the second power and the predetermined second power adjusting coefficient, and a second adjusted correlation value adjusting the second correlation value using the third power and a predetermined third power adjusting coefficient; and
the intermediate value calculating section calculates the first intermediate value using the first adjusted power instead of the first power, and calculates the second intermediate value using at least one of the first adjusted correlation value and the second adjusted correlation value instead of at least one of the first correlation value and the second correlation value, and the first adjusted power instead the first power.

5. The quantizing apparatus according to claim 1, wherein:
the power/correlation calculating section calculates second power of the first signal and third power of the second signal;
the intermediate value calculating section calculates the second intermediate value using the second correlation value and the first power, and further calculates a third intermediate value using the first correlation value, calculates a fourth intermediate value using the second power, and calculates a fifth intermediate value using the first power, the second correlation value, and the third power; and
the search section searches for the balancing weight coefficient based on the first intermediate value, the second intermediate value, the third intermediate value, the fourth intermediate value, and the fifth intermediate value, and acquires the corresponding code.

6. The quantizing apparatus according to claim 5, wherein:
the codebook further stores a first weight coefficient related to the first signal and a second weight coefficient related to the second signal, associated with the plurality of scalar values; and
the search section acquires the code corresponding to a scalar value to minimize a value obtained by applying the plurality of scalar values and the first and second weight coefficients corresponding to the plurality of scalar values, to an equation set using the first intermediate value, the second intermediate value, the third intermediate value, the fourth intermediate value, and the fifth intermediate value.

7. The quantizing apparatus according to claim 5, wherein:
the power/correlation calculating section calculates a fourth signal using the second power and the third power, calculates first adjusted power adjusting the first power using the fourth signal and a predetermined first power adjusting coefficient, and calculates a first adjusted correlation value adjusting the first correlation value using the second power and a predetermined second power adjusting coefficient, and a second adjusted correlation value adjusting the second correlation value using the third power and a predetermined third power adjusting coefficient; and
the intermediate value calculating section calculates the first intermediate value using the first adjusted power instead of the first power, calculates the second intermediate value using second adjusted correlation value and the first adjusted power instead of the second correlation value and the first power, calculates the third intermediate value using the first adjusted correlation value instead of the first correlation value and calculates the fifth intermediate value using the first adjusted power and the second adjusted correlation value instead of the first power and the second correlation value.

8. An encoding apparatus comprising:
a down mixing section that receives as input and down mixes a first signal and a second signal, and generates a third signal using a down mixing result;
a quantizing section that receives as input the first signal, the second signal and the third signal and outputs a code acquired by performing quantization with respect to two coefficients to adjust an amplitude balance of the third signal;
a coefficient determining section that determines a first balancing weight coefficient to adjust the amplitude balance of the third signal with respect to the first signal using the code, and calculates a second balancing weight coefficient to adjust the amplitude balance of the third signal with respect to the second signal using the first balancing weight coefficient; and
an encoding section that generates a first target signal using the first signal, the third signal and the first balancing weight coefficient, encodes the first target signal, generates a second target signal using the second signal, the third signal and the second balancing weight coefficient, and encodes the second target signal, wherein the quantizing section comprises:
a power/correlation calculating section that calculates a first correlation value between the first signal and the third signal and a second correlation value between the second signal and the third signal, and calculates first power of the third signal;
an intermediate value calculating section that calculates a first intermediate value using the first power, and calculates a second intermediate value using the first power and at least one of the first correlation value and the second correlation value;
a codebook that stores a plurality of scalar values; and
a search section that searches for th first balancing weight coefficient out of the plurality of scalar values based on the first intermediate value and the second intermediate value, and acquires the code corresponding a scalar value searched out.

9. A quantizing method to quantize two coefficients to adjust an amplitude balance of a third signal acquired using a down mixing result of a first signal and a second signal, the quantizing method comprising:
a power/correlation calculating step of receiving as input three signals of the first signal, second signal, and third signal, calculating a first correlation value between the first signal and the third signal and a second correlation value between the second signal and the third signal, and calculating first power of the third signal;
an intermediate value calculating step of calculating a first intermediate value using the first power, and calculating a second intermediate value using the first power and at least one of the first correlation value and the second correlation value; and
a search step of searching for a balancing weight coefficient to adjust the amplitude balance of the third signal with respect to the first signal based on the first intermediate value and the second intermediate value, out of the plurality of scalar values stored in the codebook, and acquiring a code corresponding a scalar value searched out.

10. An encoding method comprising:
a down mixing step of receiving as input and down mixing a first signal and a second signal, and generating a third signal using a down mixing result;
a quantizing step of receiving as input the first signal, the second signal and the third signal and outputting a code acquired by performing quantization with respect to two coefficients to adjust an amplitude balance of the third signal;
a coefficient determining step of determining a first balancing weight coefficient to adjust the amplitude balance of the third signal with respect to the first signal using the code, and calculating a second balancing weight coefficient to adjust the amplitude balance of the third signal with respect to the second signal using the first balancing weight coefficient; and
an encoding step of generating a first target signal using the first signal, the third signal and the first balancing weight coefficient, encoding the first target signal, generating a second target signal using the second signal, the third signal and the second balancing weight coefficient, and encoding the second target signal, wherein the quantizing step comprises:
a power/correlation calculating step of calculating a first correlation value between the first signal and the third signal and a second correlation value between the second signal and the third signal, and calculating first power of the third signal;
an intermediate value calculating step of calculating a first intermediate value using the first power, and calculating a second intermediate value using the first power and at least one of the first correlation value and the second correlation value; and
a search step of searching for the first balancing weight coefficient out of the plurality of scalar values stored in a codebook based on the first intermediate value and the second intermediate value, and acquiring the code corresponding a scalar value searched out.
